(19) United States
(12) Patent Application Publication
(10) Pub. No.: US 2015/0379589 A1
(43) Pub. Date: Dec. 31, 2015

(54) DISCERNING CASH AND FIXED ASSET DONATIONS

(71) Applicant: iDonate Liquidation, LLC, Dallas, TX (US)

(72) Inventors: Raymond Gary, JR., Dallas, TX (US); Steven Kravit, Plano, CA (US)

(21) Appl. No.: 14/751,554

(22) Filed: Jun. 26, 2015

Related U.S. Application Data
(60) Provisional application No. 62/017,989, filed on Jun. 27, 2014.

(51) Int. Cl. G06Q 30/02

(52) U.S. Cl. CPC G06Q 30/0279

(57) ABSTRACT

A system and method of processing, within a single procedure, cash equivalents and fix assets from any disposition class. The method includes identifying the benefactor and asset to be donation. Once identified, the asset is classified into one of three disposition classes. The disposition classes are used to determine the value for valuing. Once the value is determined, an impact statement is generated. Depending on the disposition class, the item is either converted to funds directly or through an intermediary. Once the item is converted to funds, the funds are transferred to the identified benefactor.

### CROSS-REFERENCE TO RELATED APPLICATIONS

A claim of priority is made in this application based on Provisional Application Ser. No. 62/017,989 filed on Jun. 27, 2014 and entitled “Discerning Cash and Fixed Asset Donations” the disclosure of which is hereby incorporated by reference in its entirety.

### FIELD OF INVENTION

The embodiments describe herein are related to a system and method of accepting and processing a variety of types of donations within one system.

### BACKGROUND

The embodiments described herein are a useful and novel method for enabling a single system to accept cash equivalents, brokered fixed assets and lead generation assets in a single online forum.

Unified Class. Systems and inventions in the prior art focus on the collection and processing of a unified class of assets. For example, there is a substantial body of art related to the donation of life insurance policies to institutions. While the exact terms of the donated insurance policies will vary widely, and unpredictably, the systems are able to uniformly handle the entire asset class. They do not present or handle assets such as business ownership or motorized vehicles.

Alternative cash donation option. An alternative for processing fixed assets and cash is to provide a would-be buyer the option of skipping the fixed asset purchase and instead provide a cash contribution to the charity the buyer had selected. In this system, the buyer goes to a classified or auction online site and conducts a search. The search leads the buyer to a list of items meeting the search requirements. Those search requirements may include the name of a charity the buyer has selected. If the buyer decides to purchase an item, a portion of the sale is given to the charity. The funds either originate from the buyer or the website's transaction manager. If the buyer is unable to find something to purchase, an item's description gives the buyer the option to make a cash contribution to the charity listed in their original item search. The somewhat improbable business model is to turn funds a shopper planned to use for a specific purpose into an unplanned donation.

Non-cash assets are all treated identically. These systems make little attempt to identify the asset class. The system is unable to value the item and relies on the honor system for tax reporting. The final collection of fixed assets is completed manually. While these types of systems are known in the industry, their relative lack of sophistication makes full automation impossible.

Multiple systems. Processing institutional gifting of both cash and fixed assets currently requires a combination of an ATM, retail point-of-sale system, title management software, and logistics planning systems. Integrating these systems if often limited by outside concerns, such as discussed in the next section, but the necessary complexity in a diverse asset donation system limits the scope of the practical functionality.

Multiple entities. In addition to requiring multiple systems, current entities that accept both cash and fixed assets have separate legal entities to handle the charitable funds and the non-charitable funds from sale of asset. Since not the all funds from the sale of the asset are for a charitable institution, the sale must also involve a for-profit legal entity. Cash would be distributed to one charitable entity and the funds for the sale of assets are distributed through a for-profit and then to the seller. For instance, at eBay, the entire fund from the sale of the asset is distributed back to the seller through their for-profit PayPal. The seller then later receives a notice that they need to transfer a portion of those funds to the charitable institution. This second transfer is executed through an independent nonprofit organization associated with eBay. The result is a complex set of separate systems and institutions.

The embodiments described below addresses these abating factors.

### SUMMARY OF THE INVENTION

The embodiments below are directed to systems and methods to convert all donated assets to transferable funds before presentation of the donation to the charity.

Accordingly, several objects and advantages of the described embodiments are:
a) to provide donors with one site to handle any type of preferred donation;
b) to provide donors with one site to donate to multiple charities;
c) to provide donors with a list of additional suggested asset from different asset classes;
d) to provide a cash conversion donation of a physical asset;
e) to provide a cash conversion, in a single system, for any type of asset; and
f) to provide liquidators access to only items they wish to broker.

### BRIEF DESCRIPTION OF THE DRAWINGS

The accompanying drawings, which are incorporated in and constitute a part of this specification, illustrate the embodiments and together with the corresponding description.

FIG. 1A illustrates a process that takes place in an integrated donation system that converts cash and fixed assets into settled funds.

FIG. 1B illustrates the process of the integrated donation system of FIG. 1A specifically highlighting the process for handling cash equivalents. For comparison, inapplicable steps for handling other asset classes have been removed.

FIG. 1C illustrates the process of the integrated donation system of FIG. 1A specifically highlighting the process for handling brokered fixed assets. For comparison, inapplicable steps for handling other asset classes have been removed.

FIG. 1D illustrates the process of the integrated donation system of FIG. 1A specifically highlighting the process for handling lead generation fixed assets. For comparison, inapplicable steps for handing other asset classes have been removed.

FIG. 1E illustrates expanded features of the process of the integrated donation system shown in FIG. 1A specifically directed to communication with parties to the donation.

FIG. 2 illustrates a process for classifying an item to determine a particular processing path within the integrated donation system.

FIG. 3 illustrates an example computer system that may be used to carry out the integrated donation system.

FIG. 4 illustrates example interactions between donor, benefactor, and integrated donation computer systems.

### DETAILED DESCRIPTION

Referring to the drawings, in which like numerals represent like elements,

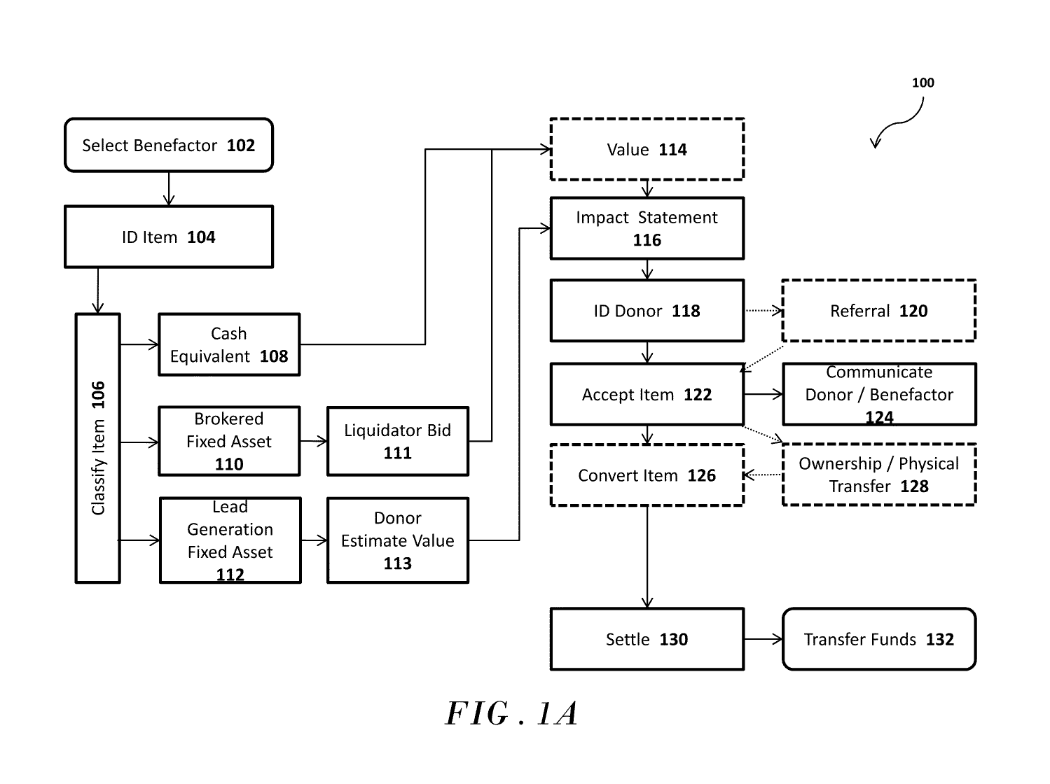

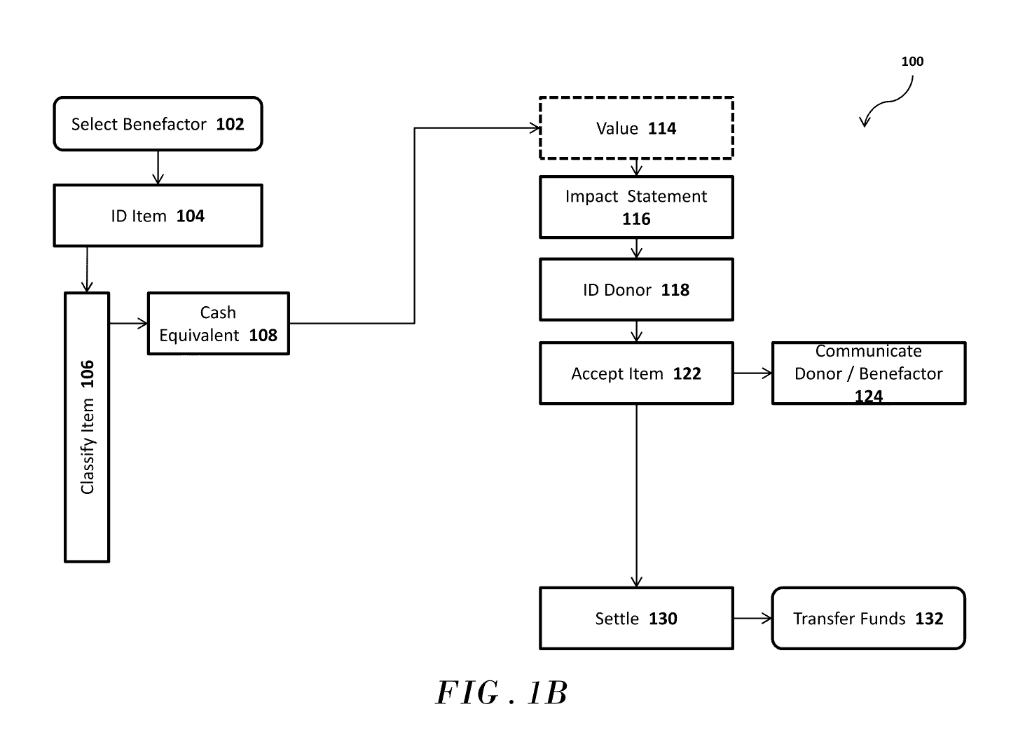

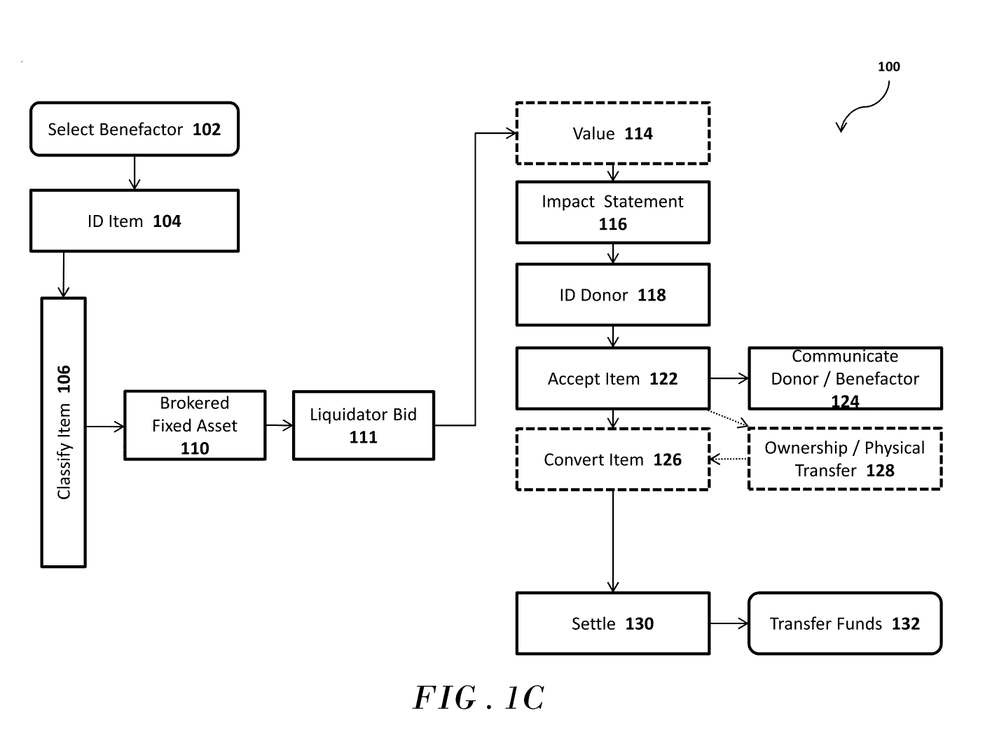

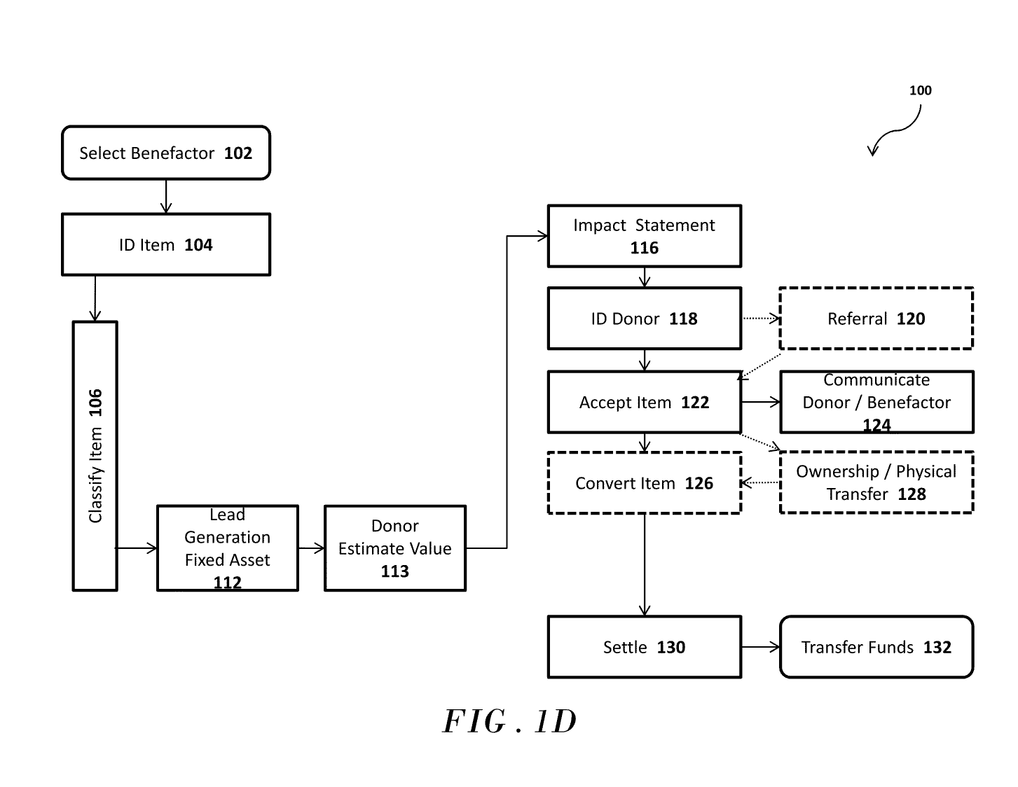

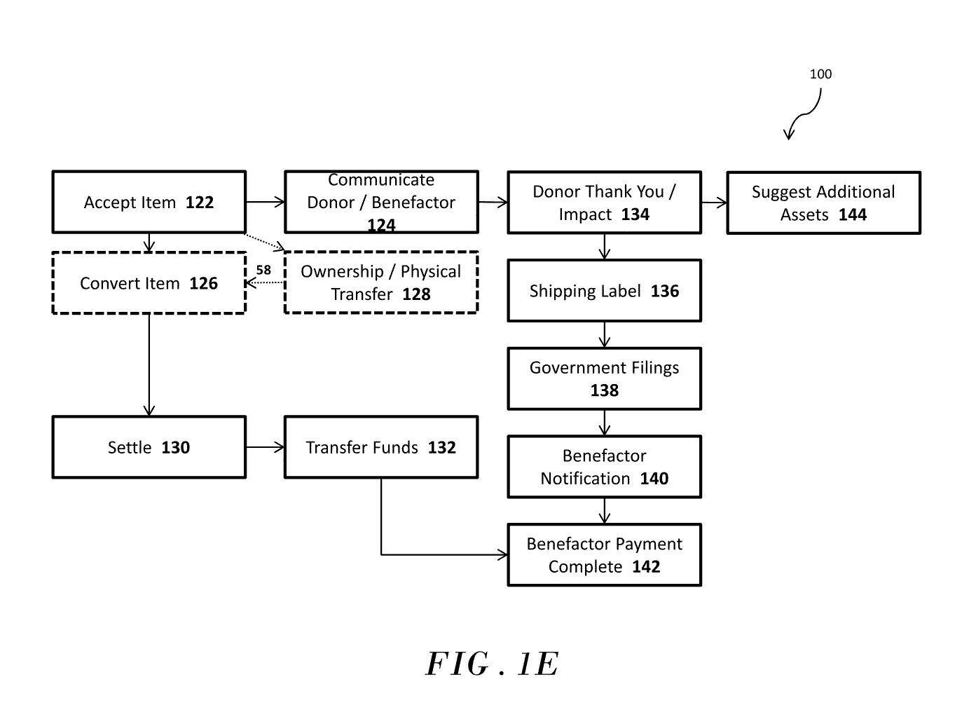

FIG. 1A illustrates a process 100 that takes place in an integrated donation system that converts cash and fixed assets into settled funds. The process may be performed from the perspective of a donor that is identified to the system by a donor ID. First, in step 102, the donor selects a benefactor. The benefactor may be any type of nonprofit entity including a charity, cause, public institution, government entity, fund, individual, private entity, account, or crowdfunding campaign.

Once the benefactor is selected, the donor must then identify the item they wish to donate in step 104. The item may be any type of tangible or intangible asset such as electronic items, cash equivalents, professional service, insurance, or a business ownership. The item is identified to the system any number of user input methods such as, for example, keying an alphanumeric description, keying an item description with predictive text provided by the system, keying a search into the system and selecting from the results, scanning a barcode, selecting from a series of hierarchical drop down boxes, graphical controls, image capture, motion detection, multimodal interaction, electronic pen, touch input, speech synthesis, face input, voice entry, electroencephalography systems, or any combination of the above. Once the item is identified, the system may associate it with a unique identifier.

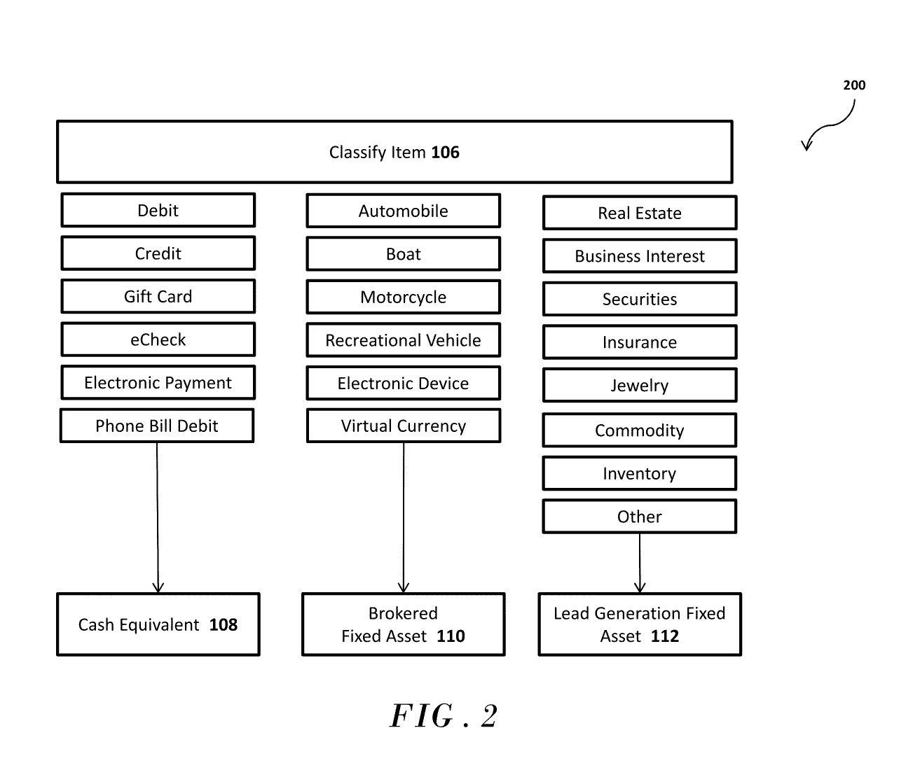

Once the donor selects the benefactor and identifies the item to the system, the system then uses the identification of the item to determine the item's disposition class in step 106. The disposition class may be based on item description stored in a database local or remote to the system. The disposition class may also be derived by the system using key words in the item description. Additionally, the donor may supply a classification with the item identification which the system could then verify against the item description and use as the classification. Disposition classes include cash equivalents 108, brokered fixed assets 110, and lead generation fixed assets 112. Examples of assets in each class are described in detail below in reference to FIG. 2. An item's disposition class determines the processing path that it will take through the system in order to be converted to cash. Each specific path is described for each class in more detail in reference to FIGS. 1B-D.

Regardless of item classification, an impact statement is generated for each item in step 116. The impact statement is based on a benefactor provided metric that converts the value of the item into the amount of assistance the benefactor will receive from the donation. The system uses the item's value derived in step 114 to calculate an impact statement. To generate an impact statement for a particular item, beneficiaries provide the system with metrics that indicate how the donated item will provide tangible benefits for the beneficiary. Examples of benefactor provided metrics are as follows:
$8.32 provides one temporary shelter for the beneficiary Red Cross;
$27.32 buys one family a week of food for the beneficiary The Pantry;
$12.00 supplies one pet with food, shelter, and care for the beneficiary Humane Society;
$50.00 will produce 12 finished products for a beneficiary startup.

Based on these and other provided metrics as well as the donated item value, the system determines impact statement for the item. For example, for an item valued at a $100, the system may generate the following impact statements:
12 temporary shelters;
4 families a week of food;
8 pet with food, shelter, and care;
24 finished products for a startup.

The impact statement helps donors understand the importance of their donation and encourages completion of the donation process. The impact statement may be provided to the donor upon determination, after the item is accepted, or after the donation process. The impact statement may be written as above, for example, or may use one or more icons to represent each portion of the statement.

Process 100 is discussed in more detail below for each disposition class in reference to FIGS. 1B-D.

FIG. 1B illustrates the process of the integrated donation system of FIG. 1A specifically highlighting the steps for handling cash equivalents. For comparison, steps in the process that do not apply to items classified as cash equivalents have been removed. As discussed in FIG. 1A, donated items are classified as one of three types. One particular type is cash equivalent item 108. Cash equivalent items include credit or credit card transactions, debit or debit card transactions, gift cards with a cash balance, electronic checks such as, for example, any electronic payment such as automatic clearing house (ACH), or payments derived from other billing services such as, for example, a mobile phone bill.

Once an item is identified as a cash equivalent, the system moves to process by assigning a value in step 114. Cash equivalents may be valued both as a gross donation and a net donation amount. Cash equivalent formats, such as credit versus debit, each have unique fees. For example, while all cash equivalent items valued at a $100 U.S. would all have the same gross value, each particular cash equivalent item would have a different net donation amount based on necessary fees. An impact statement is then generated for the item in step 116. Determining an impact statement is discussed above in reference to FIG. 1A.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the identification of the donor is complete, the system accepts the item in step 122. For cash equivalents, each specific type of asset involves different processes based on the item description. In particular, for debit and credit transactions, the system makes a charge to the donor associated account. For an electronic payment, such as a wire transfer, the system sends instructions to the donor's indicated account manager. For gift card transactions, the donor's authorization is submitted to a gift card processor with electronic instructions to transfer the amount to the system's settlement account. These are merely provided as examples and are not intended to limit the described embodiments. While cash equivalent items have the perception of being highly liquid, they may actually take several days to several weeks before their donation process is complete. For example, the donor's financial institution may suspend transferring funds to the beneficiary until the institution's settlement process is complete. In this case, the system may float the funds to the beneficiary before the transaction is actually settled by the financial institution.

The acceptance step 122 completes the necessary data to provide substantive communications to the donor, the beneficiary, and any necessary reporting agencies. The system then proceeds to communicate any information about the donation, which is discussed in more detail below, in reference to FIG. 1E.

FIG. 1C illustrates the process of the integrated donation system of FIG. 1A specifically highlighting the process for handling brokered fixed assets. For comparison, steps not required in processing brokered fixed assets have been removed. As discussed in FIG. 1A, donated items are classified as one of three types. One particular type is brokered fixed assets 110. Brokered fixed assets include automobiles, boats, motorcycles, recreational vehicles, electronic devices or virtual currency. This list is provided only as an example and is not meant to be limiting.

Once an item is classified as a brokered fixed asset, a liquidator bid is generated in step 111. To generate a liquidator bid, a request for is sent to a liquidator. The liquidator may examine the description of the item, for example, electronically by matching the description provided by the donor to a database maintained by the liquidator. The liquidator may then generate the liquidator bid. The liquidator bid represents the value the liquidator is willing to pay for the item. Once received, the liquidator bid is recorded and used as the base of the item's value. In step 114, the value of the item may be adjusted based on any required fees, such as liquidator fees or fees charged by the donation system. Thus, the item value determined in step 114 is the net value.

The system may then determine an impact statement in step 116. To determine the impact statement, the system may use either the liquidator bid or the net value of the item. As discussed above, the impact statement is determined by comparing the value against metrics provided by the beneficiary. In particular, a beneficiary may provide the system with metrics detailing the cost of providing a unit of service in order for the system to calculate how the donor's item will provide benefits for the beneficiary. For example, Meals on Wheel is able to deliver a senior one meal of prepared food for $7.00. The unit is $7.00/meal. With this information, the system may then determine the total impact for the donated item whether the value is the liquidator bid or the net value. In other words, using the above metrics, a $700 liquidator bid or net value would provide an impact statement such as:
“Your donation can be converted to 100 warm meals delivered to seniors or hospice care patients.”
“You donated computer will provide a home-bound senior one year of warm meals delivered to their residence.”

Determining an impact statement based on an item's value is discussed above in reference to FIG. 1A.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the donor identification is complete, the system moves to accept the item in step 122. As part of the acceptance process, the system communicates with the donor and beneficiary about the item's acceptance as a donation in step 124. More specifically, the system communicates to the donor requirements for transfer of title to the liquidator. This communication may include packing and shipping instructions and a shipping label.

To complete the donation process, the donor then transfers title and possession of the item to the liquidator in step 128. If the system prepared packing and shipping instructions, the donor can simply use those to transfer the item to the liquidator. Once the liquidator receives the item, it converts the item to funds to donate to the beneficiary in step 126. The funds are then transferred to the system to settle the funds in step 130 and 132. While settlement usually occurs with transfer of funds, in some cases, fund transfer may occur after the settlement or the system may anticipate the funds that the liquidator will transfer and advance the amount to the benefactor before settlement.

FIG. 1D illustrates the process of the integrated donation system of FIG. 1A specifically highlighting the process for handling lead generation fixed assets. For comparison, steps not needed for processing lead generated fixed assets have been removed. As discussed in FIG. 1A, donated items are classified as one of three types. One particular type is lead generation fixed assets 112. Lead generation fixed assets different from brokered fixed assets it is difficult for electronic liquidators to appropriately value lead generation fixed assets. Lead generation fix assets include real estate, business interest, securities, insurance, jewelry, commodity, and inventory. It may also include other assets associated with brokered fixed assets that are equally difficult to electronically value. For example, an automobile would normally be a brokered fixed asset but a classic automobile may be classified as lead generation fixed asset due to its uniqueness and the difficulty in identifying a market or resale potential.

Once an item is identified as a lead generation fixed asset, the system will proceed to determine a donor estimated value in step 113. For lead generation fixed assets, item valuation may be time consuming. In order to quickly process the asset and covert it to an amount, therefore encouraging donation, the system seeks a value for the item from the donor.

Once the value is entered by the donor, an impact statement is determined in step 116. As discussed above, the impact statement is determined by comparing a value against metrics provided by the beneficiary. For lead generation fixed assets, the system does not rely on a third-party bid for determining the value that is used in determining the impact statement. Instead, the system uses the donor estimated value. Determining an impact statement based on an item's value is discussed above in reference to FIG. 1A.

Next, donor information is collected by the system in step 118. This information may be used by the donor or the beneficiary, or communicated to government agencies, if desired. Step 118 can take place at any point in process 100 but collecting the donor information after the generating the impact statement may be helpful in completing of the donation process. Collecting donor information may include requiring the donor to fill out a form, scan a check or a credit card, link to a social media site, or logging into the system.

Once the donor information is obtained, the system sends a referral for a bid to a system that retrieves bids from potential buyers in step 120. The potential buyer can examine the description of the item and take any needed action to identify the value of the item. In some embodiments, the description examination and evaluation by the potential buyer would be done electronically by matching the description provided by the donor to a database either local or remote from the system. The buyer then provides a bid to the system which is used to establish a value for the item. The bid offer may provide an instantaneous response from the donor or be delayed in an extended period of value determination and negotiation.

Once the final bid is determined, the buyer accepts the item and the system records the acceptance in step 122. The system then communicates to the donor the requirements for transferring title to the buyer in step 124. This communication is highly dependent on the item. For items that can be shipped, the system may include packing and shipping instructions and a shipping label. Additionally, the system may notify the benefactor of the donation and the amount of funds that will be transferred to the benefactor.

To complete the donation process, the donor then transfers title and possession of the item to the liquidator in step 128. If the system prepared packing and shipping instructions, the donor can simply use those to transfer the item to the liquidator. Once the liquidator receives the item, it converts the item to funds to donate to the beneficiary in step 126. The funds are then transferred to the system to settle the funds in step 130 and 132. While settlement usually occurs with transfer of funds, in some cases, fund transfer may occur after the settlement or the system may anticipate the funds that the liquidator will transfer and advance the amount to the benefactor before settlement.

FIG. 1E illustrates expanded features of the process of the integrated donation system shown in FIG. 1A specifically directed to communication with parties to the donation. In particular, acceptance in step 122, no matter the item's classification, completes the necessary data to provide substantive communications to donor, the beneficiary, or and necessary reporting agencies. Once acceptance occurs, the system may proceed with a number of communication related steps. Communication may be in the form of an on-screen representation, electronic messaging, social media postings, or even a paper format.

For example, in step 134, the system provides a thank you message that includes an impact statement to the donor. The impact statement may be an automatically generated written statement, a graphical representation of the impact, or a combination of both. This communication may also suggest additional items from the same or different classes that can also be donated. This suggestion may be generated, in part, based on the beneficiary's, the donor's, or other donors' donation history in step 144.

For items that require shipment to be converted to funds, such as some brokered fixed assets and lead generation fixed assets, shipping labels and instructions may be communicated in step 136. These may be printed at the system or communicated to the donor's system to print at the donor's request.

In some cases, organizations or agencies may be notified of the donation in step 138. For example, donation information may need to be communicated to government agencies for filings such as taxes, title transfers. Other non-government entities may need to be notified for securities or corporate interest reporting.

In addition to the reporting in step 138, details of the donation may also be communicated to the benefactor in step 140. This communication may also include details about the system's process, timing of the item's conversion into actual funds, settlement, and anticipated timing of fund transfers. Finally, after the item is converted, physically transferred, or settled, the funds are transferred to the benefactor and the benefactor receives a communication that payment is complete in step 142.

The process described above in FIGS. 1A-1E are merely example embodiment and are not intended to limit the types of assets or the process by which assets may be converted into cash for donation to a benefactor.

FIG. 2 illustrates a process 200 for classifying an item to determine a particular processing path within the integrated donation system described in FIGS. 1A-E. As discussed above, the integrated donation system is designed to process at least three types of asset classes—cash equivalents 108, brokered fixed assets 110, and lead generation fixed assets 112. In some embodiments, once the system receives item description from the donor, the item is classified by comparing the description with an item database either local or remote to the system.

First, the item is compared against known cash equivalents in the database. Known cash equivalents include debit or debit card transactions, credit or credit card transactions, gift cards with a cash balance, electronic checks including any electronic payment such as automatic clearing house (ACH), and payments derived from other billings, such as a mobile phone bill. If the item meets any of the known cash equivalents, it may be classified and processed by the system as a cash equivalent. Although some items like gift cards may meet the description of cash equivalents, they may require reclassified to brokered fixed assets if converting the item to funds requires processing through a broker or liquidator.

Next, the item is compared against known brokered fixed assets in the database. Brokered fixed assets are those assets that are efficiently converted to funds through an automated or partially automated process by a third-party vendor contracted to provide instant bids on a group of pre-determined items. Known brokered fixed assets may include, for example, automobiles, boats, motorcycles, recreational vehicles, electronic devices, and virtual currency. The benefit with classifying an item as a brokered fixed asset is that the system can establish an instant value for the item in order to then calculate an impact statement.

Finally, items that do not fall into either the cash equivalent or brokered fixed asset classifications are classified by the system as lead generation fixed assets. Lead generation fixed assets may include, for example, real estate, business interest, securities, insurance, jewelry, commodities, and inventory. Generally speaking, though, lead generation fixed assets are different than brokered fixed assets because the system is unable to quickly obtain a third-party valuation. This may be due any number of reasons including, for example, government regulations, asset complexity, poor liquidity, rarity, etc. Despite these valuation challenges, though, the system continues the donation process by obtaining an initial value from the donor.

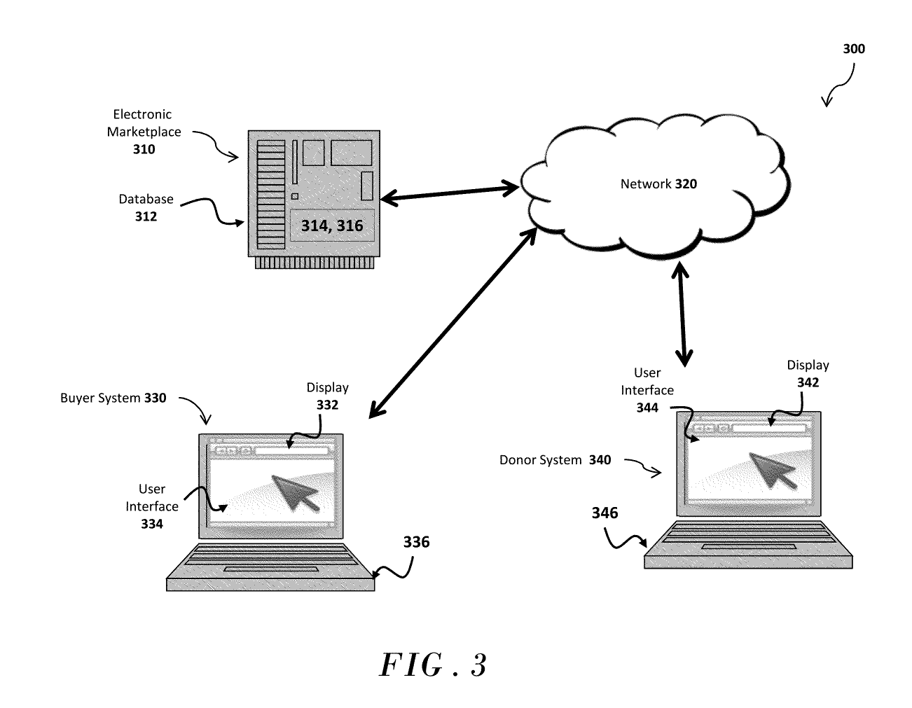

FIG. 3 illustrates an example computer system 300 that may be used to carry out the process of the integrated donation system described in FIGS. 1A-E and 2. System 300 includes an electronic marketplace system 310, a buyer system 330, and a donor system 340. These systems are connected via a network 320 such as, for example, the Internet. Electronic marketplace 310 may be the system for processing donations describe in FIGS. 1A-E and 2. Marketplace 310 includes a one or more computer processors 314, memory 316, and may include a database 312 for storing item classification information. Buyer system 330 and donor system 340 include and number of computer devices such as, for example, mobile computers, personal computers, personal digital assistants, smart phones, tablets, laptops, wearable computers, ultra-mobile personal computers, enterprise digital assistants, electronic book readers, minicomputers, mainframes, servers, workstations, minicomputers, microcomputers, desktop computer, clones and terminals.

In some embodiments, to conduct the process described in FIGS. 1A-E and 2, the donor begins by transmitting personal data via donor system 340 to the electronic marketplace 310 to establish an account. The account may include information about the donor such as name, address, government identification information, preferred benefactors, donation history, and item search history. This list is not exclusive and is not intended to limit the embodiments.

The buyer may also transmit personal information via buyer system 330 to create an account. The buyer's information may include information listed above for a donor's account as well as additional information such as, for example, shipping information and payment information. As discussed above in FIGS. 1C-D, when a donor proceeds with a transaction at the electronic marketplace 310 that requires a buyer, the buyer may receive notification of the item for sale via buyer system 330. In some embodiments, the buyer may provide the system with a wish list (e.g., a list of assets or types of assets) so that the buyer is notified only about items that the buyer is interested in. In this case, the buyer will only be notified when a broker fixed asset or lead generation fixed asset matching its requirements is available for purchase. From the buyer system 330, the buyer can examine the description of items for. In a preferred embodiment, the description examination is done electronically at the buyer system 330 by matching the description generated by the donor to a database local or remote to buyer system 330. The buyer may then purchase the item, whereby the necessary transaction information is transmitted from buyer system 330 to the electronic marketplace 310.

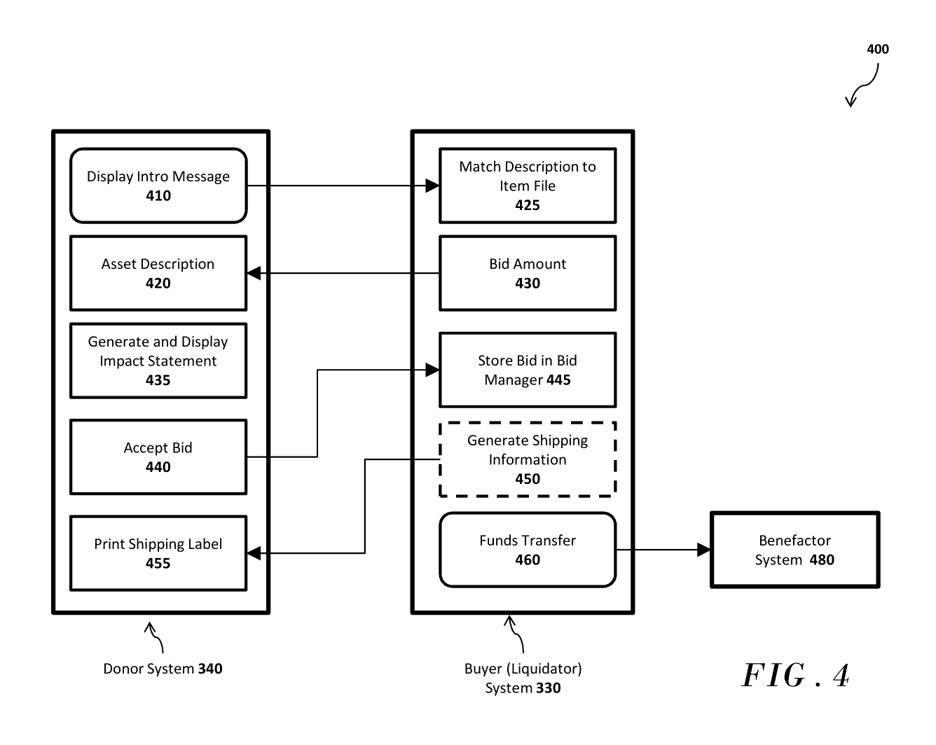

FIG. 4 illustrates an example process 400 between donor system 340, buyer system 330, and benefactor system 480. As described above in reference to FIGS. 1A-E, 2 and 3, these process steps may take place at an electronic marketplace system.

Process 400 begins in step 410. Step 410 includes soliciting asset donations from a donor via donor system 340. Typically, a web page associated with a benefactor may explain the goals of the benefactor, their successes, the global impact, or specific impacts to individuals served. In some embodiments, in order to invite a potential donor to make a donation, an introductory message is displayed inviting participation. The message would alternatively or collectively explain the outcome of the donation, display images showing the resulting impact of the donation (e.g., an impact statement), basic instructions to complete the form, pop-up detailed help, audio files, video files, or other instructional material.

Following the solicitation step 410, the potential donor enters an asset description to begin the process of receiving an individualized impact statement in step 420. Entering of the specific item description can be performed using a number of methods discussed above. For example, the donor may enter an alphanumeric asset description 52 such as “SeeO 52 LCD TV.” This may be done through donor system 340 by typing a description, selecting a specific asset from a drop down list, or a combination of both a keyed description and a drop down list. In other words, a donor may begin typing “See” and be provided an instantaneous drop down list of selections, such as:
SeeO 30 LED Television
SeeO 32 LCD Television
SeeO 32 LCD Monitor
SeeO 40 Monitor with Antenna
SeeO 52 LCD Television

The prospective donor would then select a particular asset from the resulting search list. Alternatively, the item description may be entered using an index that could be keyed-in or scanned such as a UPC.

Once entered, the item description is transmitted to the buyer system 330 and matched to a description provided by the buyer system 330. The buyer system 330 may then retrieve an associated bid amount in step 430. The bid amount includes a transaction identifier, an asset description, an amount or value. The bid amount is transmitted to the donor system 310 to prepare an impact statement to display to the prospective donor. The impact statement is then generated and displayed to the perspective donor in step 435 to encourage the prospective donor to continue with the asset donation. If the prospective donor accepts the bid amount in step 440. In some embodiments, the donor may not be shown the actual bid amount. Instead, the donor may accept, or approve, bid based only on the impact statement. In this case, the donor may select multiple impact statements or only a single impact statement.

Once the bid amount is accepted, the acceptance is transferred to the buyer system 330 and stored in step 445. In response to the bid acceptance, the buyer system 330 may generate shipping information in step 450 for those assets that can be shipped. The shipping information may then be transmitted to the donor system 330 for printing by the donor in step 455. The buyer system 330 may also email the shipping information to the donor or print and then ship the information to the donor. The shipping information may include packing and shipping materials to assist in the efficient transfer of the item.

Finally, the buyer system 330 transfers funds to the benefactor system 480 in step 460. The benefactor system 480 may be a server managed by a benefactor, a server managed by a third-party on behalf of the benefactor, a banking institution designated to receive the funds, or a third-party designated to convert the funds into the promised impact.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

In the foregoing description, and the following claims, method steps and/or actions are described in a particular order for the purposes of illustration. It should be appreciated that in alternate embodiments, the method steps and/or actions may be performed in a different order than that described. Additionally, the methods described above may be embodied in machine-executable instructions stored on one or more machine-readable mediums, such as disk drives, thumb drives or CD-ROMs. The instructions may be used to cause the machine (e.g., computer processor) programmed with the instructions to perform the method. Alternatively, the methods may be performed by a combination of hardware and software. While illustrative and presently preferred embodiments have been described in detail herein, it is to be understood that the inventive concepts may be otherwise variously embodied and employed, and that the appended claims are intended to be construed to include such variations, except as limited by the prior art.

What is claimed is:

1. A computer-implemented method for donating to a benefactor, the method comprising:
receiving, by at least one computer processor, identification data and preference data from a donor device that identifies a donor;
storing, by at least one computer processor, the identification data and the preference data in one or more databases such that the data is associated with the donor;
receiving, by at least one computer processor, an item description from the client device that describes an item that the donor intends to be converted to a monetary amount, wherein the monetary amount is to be provided to the benefactor;
receiving, by at least one computer processor, benefactor identification data, wherein the benefactor identification data indicates at least one benefactor that the donor intents to make a donation to, and wherein the benefactor identification data is associated with the donor.
matching, by at least one computer processor, the item description with a corresponding description stored in a database, wherein the corresponding description is associated with an asset classification, the asset classification indicating a particular method for converting the item to the monetary amount;
determining, by at least one computer processor, a value for the item, wherein the value is determined, at least in part, based on the asset classification;
providing, by at least one computer processor, the value to the donor device;
receiving, by at least one computer processor, an acceptance command from the donor device, wherein the acceptance command indicates the donor's intent to donate the monetary amount indicated by the value;
based on receiving the acceptance command, converting, by at least one computer processor, the item into the monetary amount indicated by the value; and
transferring, by at least one computer processor, the monetary amount to one or more benefactors based on the benefactor identification data.

2. The method of claim 1, further comprising:
generating, by at least one computer processor, a one or more impact statements, wherein the impact statements are based on the value and one or metrics provided by one or more benefactors based on the benefactor identification data; and
providing the one or more impact statements to the donor device.

3. The method of claim 1, wherein determining the value for the item includes:
providing the item description to one or more electronic liquidator systems; and
receiving a bid amount from the one or more electronic liquidator systems, wherein the bid amount is designated as the value for the item.

4. The method of claim 3, wherein converting the item into the monetary amount includes:
providing instructions to the donor via the donor device to transfer the item to an entity designated by the liquidator system; and
receiving the monetary amount indicated by the value from the entity designated by the liquidator system.

5. The method of claim 4, wherein transferring the monetary amount to one or more benefactors includes:
transferring the monetary amount to the one or more benefactors prior to receiving the monetary amount from the entity designated by the liquidator system.

6. The method of claim 1, wherein determining the value for the item includes:
receiving the value of the item from the donor via the donor device;
providing the item description and the value to one or more liquidator systems;
receiving a negotiated value from at least one of the one or more liquidator systems, wherein the negotiated value is designated as the value for the item.

7. The method of claim 6, wherein converting the item into the monetary amount includes:
providing instructions to the donor via the donor device to transfer the item to an entity designated by the liquidator system; and
receiving the monetary amount indicated by the value from the entity designated by the liquidator system.

8. The method of claim 7, wherein transferring the monetary amount to one or more benefactors includes:
transferring the monetary amount to the one or more benefactors prior to receiving the monetary amount from the entity designated by the liquidator system.

9. The method of claim 1, wherein providing the value to the donor device includes:
generating, by at least one computer processor, a one or more impact statements, wherein the impact statements are based on the value and one or metrics provided by one or more benefactors based on the benefactor identification data; and
providing the one or more impact statements to the donor device as the value.

10. An electronic market place computer system for facilitating donation of a monetary amount to one or more benefactors, comprising:
at least one computer processor electronically coupled to memory, the processor configured to carry out the following process stored as instructions in memory:
receive identification data and preference data from a donor device that identifies a donor;
store the identification data and the preference data in one or more databases such that the data is associated with the donor;
receive an item description from the client device that describes an item that the donor intends to be converted to a monetary amount, wherein the monetary amount is to be provided to the benefactor;
receive benefactor identification data, wherein the benefactor identification data indicates at least one benefactor that the donor intents to make a donation to, and wherein the benefactor identification data is associated with the donor.
match the item description with a corresponding description stored in a database, wherein the corresponding description is associated with an asset classification, the asset classification indicating a particular method for converting the item to the monetary amount;
determine a value for the item, wherein the value is determined, at least in part, based on the asset classification;
provide the value to the donor device;
receive an acceptance command from the donor device, wherein the acceptance command indicates the donor's intent to donate the monetary amount indicated by the value;
based on receiving the acceptance command, convert the item into the monetary amount indicated by the value; and
transfer the monetary amount to one or more benefactors based on the benefactor identification data.

11. The method of claim 10, further comprising:
generating, by at least one computer processor, a one or more impact statements, wherein the impact statements are based on the value and one or metrics provided by one or more benefactors based on the benefactor identification data; and
providing the one or more impact statements to the donor device.

12. The method of claim 10, wherein determining the value for the item includes:
providing the item description to one or more electronic liquidator systems; and
receiving a bid amount from the one or more electronic liquidator systems, wherein the bid amount is designated as the value for the item.

13. The method of claim 12, wherein converting the item into the monetary amount includes:
providing instructions to the donor via the donor device to transfer the item to an entity designated by the liquidator system; and
receiving the monetary amount indicated by the value from the entity designated by the liquidator system.

14. The method of claim 13, wherein transferring the monetary amount to one or more benefactors includes:
transferring the monetary amount to the one or more benefactors prior to receiving the monetary amount from the entity designated by the liquidator system.

15. The method of claim 10, wherein determining the value for the item includes:
receiving the value of the item from the donor via the donor device;
providing the item description and the value to one or more liquidator systems;
receiving a negotiated value from at least one of the one or more liquidator systems, wherein the negotiated value is designated as the value for the item.

16. The method of claim 15, wherein converting the item into the monetary amount includes:
providing instructions to the donor via the donor device to transfer the item to an entity designated by the liquidator system; and
receiving the monetary amount indicated by the value from the entity designated by the liquidator system.

17. The method of claim 16, wherein transferring the monetary amount to one or more benefactors includes:
transferring the monetary amount to the one or more benefactors prior to receiving the monetary amount from the entity designated by the liquidator system.

18. The method of claim 10, wherein providing the value to the donor device includes:
generating, by at least one computer processor, a one or more impact statements, wherein the impact statements are based on the value and one or metrics provided by one or more benefactors based on the benefactor identification data; and
providing the one or more impact statements to the donor device as the value.

19. A computer-implemented method for donating to a benefactor, the method comprising:
receiving, by at least one computer processor, identification data and preference data from a donor device that identifies a donor;
storing, by at least one computer processor, the identification data and the preference data in one or more databases such that the data is associated with the donor;
receiving, by at least one computer processor, an item description from the client device that describes an item that the donor intends to be converted to a monetary amount, wherein the monetary amount is to be provided to the benefactor;
receiving, by at least one computer processor, benefactor identification data, wherein the benefactor identification data indicates at least one benefactor that the donor intents to make a donation to, and wherein the benefactor identification data is associated with the donor.
matching, by at least one computer processor, the item description with a corresponding description stored in a database, wherein the corresponding description is associated with an asset classification, the asset classification indicating a particular method for converting the item to the monetary amount;
determining, by at least one computer processor, a value for the item, wherein the value is determined, at least in part, based on the asset classification;
generating, by at least one computer processor, a one or more impact statements, wherein the impact statements are based on the value and one or metrics provided by one or more benefactors based on the benefactor identification data; and
providing the one or more impact statements to the donor device.
receiving, by at least one computer processor, an acceptance command from the donor device, wherein the acceptance command indicates the donor's intent to donate the monetary amount indicated by the impact statement;
based on receiving the acceptance command, converting, by at least one computer processor, the item into the monetary amount corresponding to the impact statement; and
transferring, by at least one computer processor, the monetary amount to one or more benefactors based on the benefactor identification data.

20. The method of claim 19, wherein converting the item into the monetary amount includes:
providing instructions to the donor via the donor device to transfer the item to an entity designated by a liquidator system; and
receiving the monetary amount corresponding to the impact statement from the entity designated by the liquidator system.
